(19) United States
(12) Patent Application Publication
(10) Pub. No.: US 2014/0351039 A1
(43) Pub. Date: Nov. 27, 2014

(54) Time-restricted Product sale Promotion System and Method thereof

(71) Applicants: Hai Chiang, Pingtung (TW); Shao-Yin Cheng, Pingtung (TW)

(72) Inventors: Hai Chiang, Pingtung (TW); Shao-Yin Cheng, Pingtung (TW)

(21) Appl. No.: 13/902,887

(22) Filed: May 27, 2013

(51) Int. Cl. G06Q 30/02

(52) U.S. Cl. CPC G06Q 30/0235
USPC 705/14.35

(57) ABSTRACT

A time-restricted product sale promotion system includes a promotion platform, at least one seller system, at least one buyer system and a promotion management unit. A time-restricted product sale promotion method includes: providing a time-restricted degressive mechanism on the promotion platform and connecting with a real-time price reporting system to generate a real-time price reference; a seller utilizing the mechanism to calculate optimum degressive sale prices within a restricted promotion time interval and sending the optimum degressive sale prices and the real-time price reference to a buyer; the buyer sending a purchase order to the promotion platform according to the promotion price; comparing the promotion price with the purchase order; displaying a bargain information on the promotion platform if the purchase order is verified.

### BACKGROUND OF THE INVENTION

1. Field of the Invention

The present invention relates to a time-restricted product sale promotion system and method thereof. More particularly, the present invention relates to the time-restricted degressive product sale promotion system and method thereof

2. Description of the Related Art

U.S. Patent Appl. Pub. No. 20080189200, entitled “DEGRESSIVE AUCTION METHOD,” discloses a degressive method for an auction process comprising: offering at least one item for sale; setting an initial maximum price, a minimum price and a degressive rule; receiving bidding from buyers, and a current price is decreased according to the degressive rule until the auction is ended. A degressive auction system further disclosed comprises an input device for inputting an initial maximum price, a minimum price and a degressive rule; and a control device for receiving bidding from buyers, and the control device decreases the current price according to the degressive rule until the auction is terminated.

Another U.S. Pat. No. 7,062,460, entitled “On-line auction method and system facilitating the sale of multiple product units at prices varying with volume,” discloses an online auction system for auctioning off products, including a server system, plural buyer systems, and plural seller systems. The server system further comprises a seller interface, a buyer interface, a price adjustment mechanism, and a bid manager. The seller interface performs an online bid setup process including obtaining, from a given seller system, price varying information and quantity information corresponding to the price varying information. The buyer interface communicates, to select buyer systems, bid information and product information, and accepts from a given buyer system a given quantity needed and a given bid. The price adjustment mechanism determines a given parity price for the given buyer, which varies according to the given quantity needed. The bid manager defines a given winning bid for the given buyer as a function of the given parity price and a rank of the given buyer in relation to other buyers.

However, the auction method or system disclosed in U.S. Patent Appl. Pub. No. 20080189200 or U.S. Pat. No. 7,062,460 exists a need of improving a conventional auction method for incorporating a total amount of sale products or incorporating a real-time price-reporting system. The above-mentioned patents are incorporated herein by reference for purposes including, but not limited to, indicating the background of the present invention and illustrating the state of the art.

As is described in greater detail below, the present invention provides a time-restricted product sale promotion system and method thereof. A degressive mechanism and a real-time price-reporting system are provided to automatically adjust and generate an optimum sale price so as to avoid the failure of product sale promotion in such a way as to mitigate and overcome the above problem.

### SUMMARY OF THE INVENTION

The primary objective of this invention is to provide a time-restricted product sale promotion system and method thereof. A product sale promotion platform connects between a plurality of buyer systems and a plurality of seller systems for communicating sale product information. Accordingly, the time-restricted product sale promotion system and method of the present invention is successful in promoting sale products.

Another objective of this invention is to provide a time-restricted product sale promotion system and method thereof. A time-restricted degressive mechanism and a real-time price-reporting system are provided to automatically adjust and generate an optimum degressive sale price of sale products. Accordingly, the time-restricted product sale promotion system and method of the present invention is successful in outselling competitiveness sale products.

The time-restricted product sale promotion system in accordance with an aspect of the present invention includes:

a product sale promotion platform providing a time-restricted degressive mechanism and connecting with a real-time price-reporting system;

at least one seller system connected with the product sale promotion platform on which to provide at least one sale product and promotion prices thereof, thereby calculating and adjusting the promotion prices within a total restricted promotion time interval by the degressive mechanism to generate a series of optimum degressive sale prices of the sale product and a time schedule, and generating a real-time price reference from the real-time price-reporting system;

at least one buyer system connected with the product sale promotion platform to receive the optimum degressive sale prices and the real-time price reference, thereby sending out a purchase order to the seller system via the product sale promotion platform according to the selected optimum degressive sale price with the time schedule; and

a promotion management unit connected with the product sale promotion platform to receive data of the sale product, the optimum degressive sale prices and the purchase order for comparing the purchase order with the corresponding optimum degressive sale price;

wherein if the corresponding optimum degressive sale price and the purchase order are completely verified, bargain data are displayed on the product sale promotion platform.

The time-restricted product sale promotion method in accordance with another aspect of the present invention includes the steps of:

providing a time-restricted degressive mechanism on a product sale promotion platform and providing a real-time price-reporting system to connect with the product sale promotion platform;

connecting a seller system to the product sale promotion platform to provide at least one sale product and promotion prices thereof, calculating and adjusting the promotion prices within a total restricted promotion time interval by the degressive mechanism to generate a series of optimum degressive sale prices of the sale product and a time schedule, and generating a real-time price reference from the real-time price-reporting system;

sending out the optimum degressive sale prices and the real-time price reference to a buyer system;

connecting the buyer system to the product sale promotion platform to send out a purchase order to the seller system via the product sale promotion platform according to the selected optimum degressive sale price with the time schedule;

comparing the purchase order with the corresponding optimum degressive sale price by a promotion management unit; and

displaying bargain data on the product sale promotion platform if the corresponding optimum degressive sale price and the purchase order are completely verified.

In a separate aspect of the present invention, the seller system connects with the product sale promotion platform to preset at least one time interval and total times of degressive promotion by the time-restricted degressive mechanism.

In a further separate aspect of the present invention, the time-restricted degressive mechanism includes at least one correlation between degressive promotion prices and time.

In a further separate aspect of the present invention, the optimum sale prices further combines with different extra bonuses or discount coupons.

In yet a further separate aspect of the present invention, the sale product includes a combination of different promotion items which are provided to calculate a total of the promotion prices of the combination of the different promotion items, or the sale product includes a limited quantity of at least one promotion item which is provided to calculate and adjust the promotion prices of the limited quantity of the promotion items.

In yet a further separate aspect of the present invention, the promotion prices include an initial promotion price, a plurality of degressive promotion prices and a final promotion price.

In yet a further separate aspect of the present invention, the real-time price-reporting system connects with at least one shopping website or shopping center to receive real-time prices of products therefrom.

In yet a further separate aspect of the present invention, comparing the real-time price reference with the optimum degressive sale prices for generating a differential price table between the real-time price reference and the optimum degressive sale prices.

In yet a further separate aspect of the present invention, the time schedule has degressive time intervals to compact a promotion time step by step.

In yet a further separate aspect of the present invention, the time schedule has at least one extended time interval to extend a promotion time or at least one shortened time interval to surprisingly shorten a promotion time.

Further scope of the applicability of the present invention will become apparent from the detailed description given hereinafter. However, it should be understood that the detailed description and specific examples, while indicating preferred embodiments of the invention, are given by way of illustration only, since various modifications will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic block diagram of a time-restricted product sale promotion system in accordance with a preferred embodiment of the present invention.

FIG. 2 is schematic diagrams of degressive promotion tables with different correlations between promotion prices and time and a differential price table applied in the time-restricted product sale promotion system and method in accordance with a preferred embodiment of the present invention.

FIG. 3 is a flow chart of the time-restricted product sale promotion method in accordance with a first preferred embodiment of the present invention.

FIG. 4 is a flow chart of the time-restricted product sale promotion method in accordance with a second preferred embodiment of the present invention.

### DETAILED DESCRIPTION OF THE INVENTION

It is noted that a time-restricted product sale promotion system and method in accordance with the preferred embodiment of the present invention is suitable for various Internet trading systems or e-shop systems, for example: on-line shopping systems, which are not limitative of the present invention. The time-restricted product sale promotion system and method in accordance with the preferred embodiment of the present invention is further suitable for various e-commence systems, for example: B2B or B2C e-commence systems, which are not limitative of the present invention.

The time-restricted product sale promotion system and method in accordance with the preferred embodiment of the present invention is implemented by computer-executable steps on various computer equipments, for example: desktop computers, laptop computers, workstation computers and etc. Furthermore, the time-restricted product sale promotion system and method in accordance with the preferred embodiment of the present invention can be operated or accessed via various network systems, for example: Internet, local area networks (LAN), or various wireless local area networks (wireless LAN), which are not limitative of the present invention.

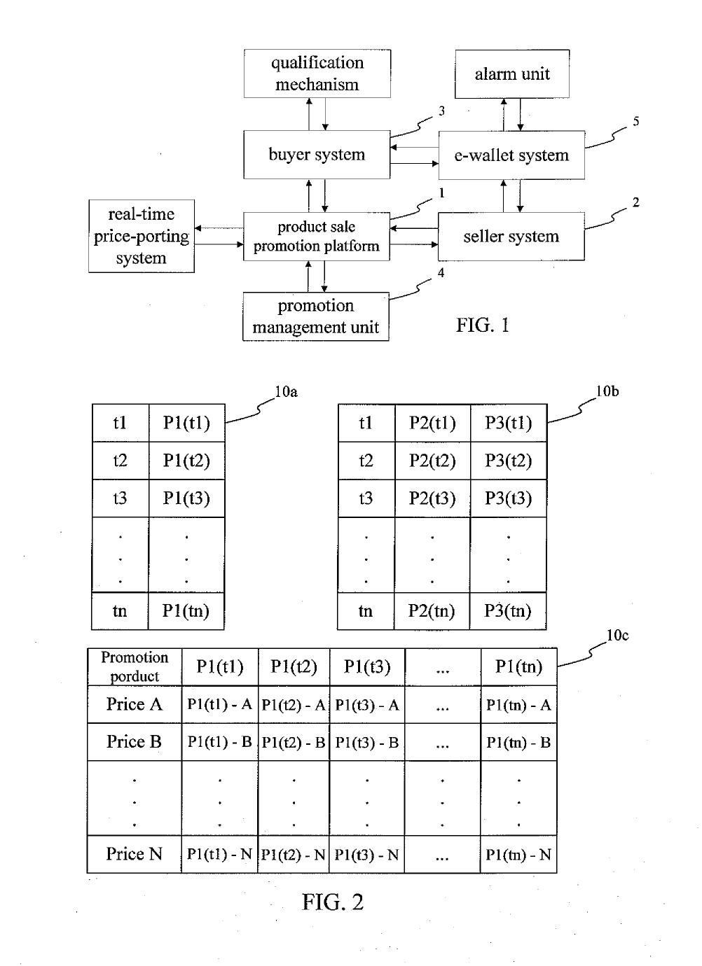

FIG. 1 shows six schematic blocks to describe the time-restricted product sale promotion system in accordance with a preferred embodiment of the present invention. Referring to FIG. 1, the time-restricted product sale promotion system in accordance with the preferred embodiment of the present invention includes a product sale promotion platform 1, a plurality of seller systems 2, a plurality of buyer systems 3, a promotion management unit 4 and other units (e.g. qualification mechanism, alarm unit or real-time price-reporting system) which are connected, wherein the number of the seller systems 2 and the buyer systems 3 can be increased or reduced according to the need.

Preferably, the product sale promotion platform 1 is provided in a server computer or the like. The seller systems 2 and the buyer systems 3 are selected from various computer systems (e.g. desktop computers) or various mobile communication devices, for example: laptop computers, sub-notebook computers or netbook computers, tablet computers or smart phones. In a preferred embodiment, each buyer should have a bank account (or e-wallet) with a predetermined minimum deposit for joining the time-restricted product sale promotion system and therefore the bank account is automatically checked by the qualification mechanism in determining the amount of purchase prior to sending out each purchase order. By way of example, the minimum deposit may be 30% or more of the total amount of the purchase order, initial promotion prices or original prices. If the total amount of the purchase order is less than the minimum deposit, no purchase order can be successfully sent out in the time-restricted product sale promotion system and will be considered as unqualified.

FIG. 2 shows two degressive promotion tables each of which has a correlation between promotion prices and time applied in the time-restricted product sale promotion system, as best shown in FIG. 1, in accordance with the preferred embodiment of the present invention. Referring to FIGS. 1 and 2, the product sale promotion platform 1 of the present invention includes a server unit provided with a degressive mechanism and a real-time price-reporting system. By way of example, the degressive mechanism is executed to generate a plurality of degressive promotion tables 10a and 10b with different correlations between degressive promotion prices and time, as shown in FIG. 2. The degressive promotion tables 10a and 10b, each of which has a correlation between promotion prices and time, are applied to preset various time intervals and total times of degressive promotion for sale products by sellers so that the product sale promotion platform 1 can generate a series of optimum sale prices of sale products and a time schedule.

With continued reference to FIG. 2, for example, the degressive promotion table 10a, which is designated to a single sale product, includes a time schedule of t1, t2, t3 . . . tn corresponding to the optimum sale prices P1(t1), P1(t2), P1(t3) . . . P1(tn) which is preferably calculated by a degressive equation. In an alternative embodiment, the optimum sale prices P1(t1), P1(t2), P1(t3) . . . P1(tn) further combines with different extra bonuses or discount coupons which are provided by the same seller or different sellers. The degressive promotion table 10b, which is designated to a combination of two or more sale products, includes a time schedule of t1, t2, t3 . . . tn corresponding to the optimum sale prices P2(t1), P2(t2), P2(t3) . . . P2(tn) of first sale product and corresponding to the optimum sale prices P3(t1), P3(t2), P3(t3) . . . P3(tn) of second sale product.

Still referring to FIGS. 1 and 2, the product sale promotion platform 1 will receive updated prices (e.g. Price A, Price B . . . and Price N) from the real-time price-reporting system to generate a real-time price reference. The product sale promotion platform 1 is operated to compare the real-time price reference with the optimum degressive sale prices for generating a differential price table 10c between the real-time price reference and the optimum degressive sale prices (e.g. P1(t1)−Price A, P1(t2)−Price A, P1(t3)−Price A . . . P1(tn)−Price A), as best shown in FIG. 2.

The time schedule has a constant time interval which can be preset by a seller. In a preferred embodiment, the time schedule has degressive time intervals to compact a promotion time step by step. For example, the time interval (t2−t1) is larger than that of (t3−t2). In an alternative embodiment, the time schedule has at least one extended time interval to extend a promotion time or at least one shortened time interval to surprisingly shorten a promotion time.

Referring back to FIG. 1, the seller system 2 connects with the product sale promotion platform 1 on which to provide at least one sale product (e.g. electronic devices, fruits or flowers), quantity and promotion prices thereof. The product sale promotion platform 1 automatically connects with the real-time price-reporting system, thereby generating a real-time price reference from the real-time price-reporting system. The product sale promotion platform 1 is automatically operated to calculate and adjust the promotion prices within a total restricted promotion time interval by the degressive mechanism to generate a series of optimum degressive sale prices of the sale product and a time schedule, as best shown in FIG. 2. The promotion prices include an initial promotion price, a plurality of degressive promotion prices and a final promotion price which can be preset via the seller system 2.

In a preferred embodiment, the seller system 2 is operated to automatically send out the optimum degressive sale prices and the real-time price reference via the product sale promotion platform 1 to the predetermined buyer system 3 or the product sale promotion platform 1 is controlled to automatically send out the optimum degressive sale prices and the real-time price reference to the predetermined buyer system 3.

By way of example, the sale product may be a limited quantity of at least one promotion item or a promotion item with a due date or an expiration date. The product sale promotion will be automatically ended if the limited quantity of the promotion items sells out, the expiration date is due or the time of the total restricted promotion time interval runs out.

Still referring to FIG. 1, the buyer system 3 connects with the product sale promotion platform 1 to receive the optimum degressive sale prices, the real-time price reference and other commercial information (e.g. advertisement). Accordingly, the buyer system 3 is operated to send out a purchase order to the seller system 2 via the product sale promotion platform 1 according to the selected optimum degressive sale price with the time schedule. In an alternative, the product sale promotion platform 1 will be automatically processed a verification procedure with the buyer system 3 in response to the purchase order.

With continued reference to FIG. 1, the promotion management unit 4 connects with the product sale promotion platform 1 to receive data of the sale product, the optimum degressive sale prices and the purchase order for comparing the purchase order with the corresponding optimum degressive sale price. If the corresponding optimum degressive sale price and the purchase order are completely verified, bargain data are displayed on the product sale promotion platform 1.

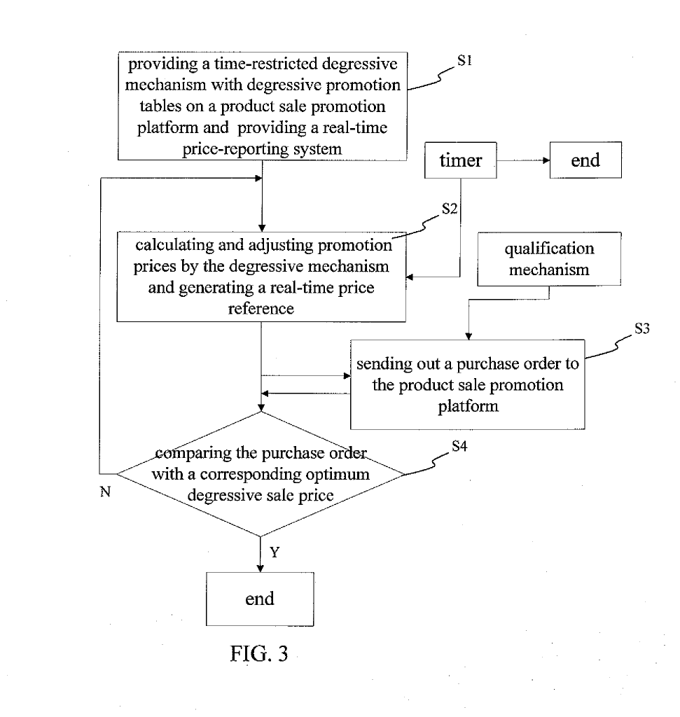

FIG. 3 shows a flow chart of the time-restricted product sale promotion method executed by the time-restricted product sale promotion system, as shown in FIG. 1, in accordance with the first preferred embodiment of the present invention. Referring again to FIGS. 1, 2 and 3, the time-restricted product sale promotion method in accordance with the first preferred embodiment of the present invention includes the step S1: providing the time-restricted degressive mechanism with the degressive promotion tables 10a or 10b on the product sale promotion platform 1 and further providing the real-time price-reporting system to connect with the product sale promotion platform 1. Accordingly, the product sale promotion platform 1 will be operated to obtain the real-time price reference (i.e. promotion prices shown in catalogues or on-line advertisement of other brands) from the real-time price-reporting system. For example, the real-time price-reporting system connects with at least one shopping website or shopping center to receive real-time prices of products therefrom.

With continued reference to FIGS. 1, 2 and 3, the time-restricted product sale promotion method in accordance with the first preferred embodiment of the present invention includes the step S2: connecting the seller system 2 to the product sale promotion platform 1 to provide at least one sale product, quantity and promotion prices thereof by a seller. The product sale promotion platform 1 is operated to obtain the real-time price reference from the real-time price-reporting system which can be observed by the seller system 2. The product sale promotion platform 1 is operated to calculate and adjust the promotion prices within the total restricted promotion time interval (e.g. 10 minutes) by the degressive mechanism. The differences of the optimum degressive sale prices (e.g. P1(t2)−P1(t1), P1(t3)−P1(t1) or P1(tn)−P1(t1)), the differences between the original price and the optimum degressive sale prices, or the differences between the real-time price reference and the optimum degressive sale prices are calculated. Consequently, a series of the optimum degressive sale prices of the sale product and the time schedule are generated in the product sale promotion platform 1.

Referring back to FIG. 2, for example, the optimum degressive sale prices include an initial promotion price P1(t1), a plurality of degressive promotion prices P1(t2), P1(t3) and a final promotion price P1(tn). The seller can utilizes the degressive promotion tables 10a or 10b to preset and execute the initial promotion price, the degressive promotion prices and the final promotion price on the product sale promotion platform 1. When the promotion prices are completely calculated, the product sale promotion platform 1 is operated to start a timer to count down for the time-restricted product sale promotion.

Referring again to FIGS. 1 and 3, the time-restricted product sale promotion method in accordance with the alternative preferred embodiment of the present invention further includes the step: sending out the optimum degressive sale prices and the real-time price reference to the predetermined buyer system 3. In an alternative embodiment, the seller can connects with the buyer system 3, other online shopping centers or online stores via the product sale promotion platform 1 to notify the optimum degressive sale prices of the sale product, the time schedule and the real-time price reference by emails or text messages.

Referring again to FIGS. 1 and 3, the time-restricted product sale promotion method in accordance with the first preferred embodiment of the present invention includes the step S3: connecting the buyer system 3 to the product sale promotion platform 1 to send out a purchase order to the seller system 3 via the product sale promotion platform 1 by a buyer according to the selected optimum degressive sale price with the time schedule. Accordingly, the promotion management unit 4 will receive the data of the purchase order and the corresponding optimum degressive sale price from the product sale promotion platform 1. In a preferred embodiment, the qualification mechanism is automatically operated to generate a fee schedule of minimum amount of deposit for each of the initial promotion step, the degressive promotion steps and the final promotion step in the beginning of the promotion. Prior to sending out a purchase order, the method further includes the step: automatically comparing the predetermined minimum deposit (calculated from the total amount of the purchase order) with the balance of the bank account by the qualification mechanism for qualification of the buyer.

Still referring to FIGS. 1, 2 and 3, the time-restricted product sale promotion method in accordance with the first preferred embodiment of the present invention includes the step S4: automatically comparing the purchase order with the corresponding optimum degressive sale price by the promotion management unit 4 to generate successful bargain data. The product sale promotion platform 1 will be operated to display the bargain data on the product sale promotion platform if the corresponding optimum degressive sale price and the purchase order are completely verified. Consequently, the successful bargain data is recorded and further sent to the seller system 2 and the buyer system 3 by emails or text messages. In a preferred embodiment, the purchase order cannot be cancelled and the payment is non-refundable if the purchase order is verified.

Referring again to FIG. 1, the seller and the buyer can use an e-wallet system 5 for collection of payment (i.e. electronically inward remittance or outward remittance) while operating the product sale promotion platform 1. When the seller or the buyer are authorized to use the e-wallet system 5, the inward remittance, outward remittance and extra bonuses are remitted to designated bank accounts of the seller system 2 and the buyer system 3.

With continued reference to FIG. 1, the product sale promotion platform 1 further includes an alarm unit. By way of example, the alarm unit will be generate an alarm signal to the product sale promotion platform 1, the seller system 2 and the buyer system 3 if the e-wallet system 5 is abnormal, overdraft or is inappropriately used by shopaholics.

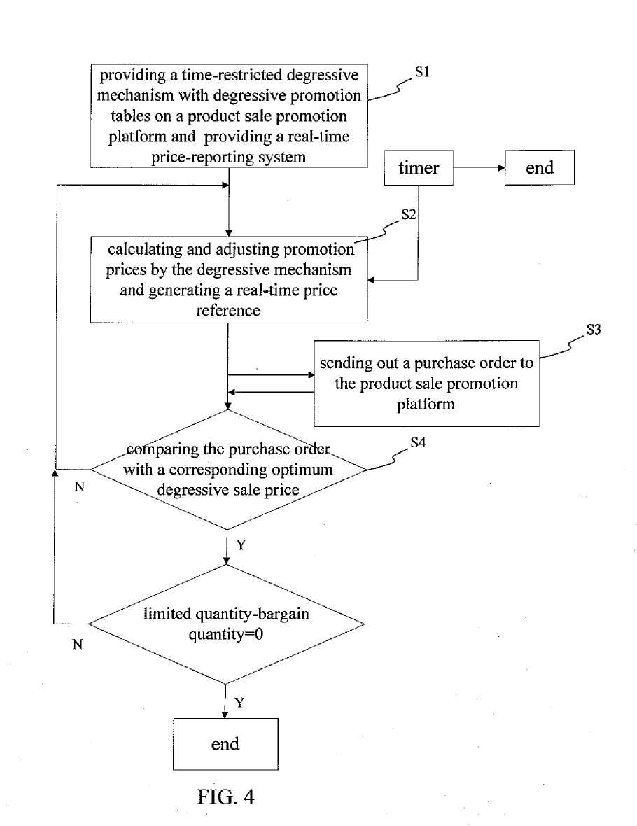

FIG. 4 shows another flow chart of the time-restricted product sale promotion method in accordance with the second preferred embodiment of the present invention similar to that shown in FIG. 3. Referring to FIGS. 1 and 4, the time-restricted product sale promotion method in accordance with the second preferred embodiment of the present invention further includes the step: comparing a limited quantity of the sale products with a successful bargain quantity of the sale products so as to decide continuing or terminating the time-restricted product sale promotion.

Still referring to FIGS. 1 and 4, by way of example, the promotion management unit 4 is operated to subtract the successful bargain quantity from the limited quantity of the sale products. If the result is greater than zero, the time-restricted product sale promotion will be automatically continued. Conversely, if the result is equal to or smaller than zero, the time-restricted product sale promotion will be automatically terminated.

Although the invention has been described in detail with reference to its presently preferred embodiment(s), it will be understood by one of ordinary skill in the art that various modifications can be made without departing from the spirit and the scope of the invention, as set forth in the appended claims.

What is claimed is:

1. A time-restricted product sale promotion system comprising:
a product sale promotion platform providing a time-restricted degressive mechanism and connecting with a real-time price-reporting system;
at least one seller system connected with the product sale promotion platform on which to provide at least one sale product and promotion prices thereof, thereby calculating and adjusting the promotion prices within a total restricted promotion time interval by the degressive mechanism to generate a series of optimum degressive sale prices of the sale product and a time schedule, and generating a real-time price reference from the real-time price-reporting system;
at least one buyer system connected with the product sale promotion platform to receive the optimum degressive sale prices and the real-time price reference, thereby sending out a purchase order to the seller system via the product sale promotion platform according to the selected optimum degressive sale price with the time schedule; and
a promotion management unit connected with the product sale promotion platform to receive data of the sale product, the optimum degressive sale prices and the purchase order for comparing the purchase order with the corresponding optimum degressive sale price;
wherein if the corresponding optimum degressive sale price and the purchase order are completely verified, bargain data are displayed on the product sale promotion platform.

2. The time-restricted product sale promotion system as defined in claim 1, wherein the seller system connects with the product sale promotion platform to preset at least one time interval and total times of degressive promotion by the time-restricted degressive mechanism.

3. The time-restricted product sale promotion system as defined in claim 1, wherein the time-restricted degressive mechanism includes at least one correlation between degressive promotion prices and time.

4. The time-restricted product sale promotion system as defined in claim 1, wherein the optimum sale prices further combines with different extra bonuses or discount coupons.

5. The time-restricted product sale promotion system as defined in claim 1, wherein the sale product includes a combination of different promotion items which are provided to calculate a total of the promotion prices of the combination of the different promotion items.

6. The time-restricted product sale promotion system as defined in claim 1, wherein the promotion prices include an initial promotion price, a plurality of degressive promotion prices and a final promotion price.

7. The time-restricted product sale promotion system as defined in claim 1, wherein the real-time price-reporting system connects with at least one shopping website or shopping center to receive real-time prices of products therefrom.

8. The time-restricted product sale promotion system as defined in claim 1, further comprising the step: comparing the real-time price reference with the optimum degressive sale prices for generating a differential price table between the real-time price reference and the optimum degressive sale prices.

9. The time-restricted product sale promotion system as defined in claim 1, wherein the time schedule has degressive time intervals to compact a promotion time step by step.

10. The time-restricted product sale promotion system as defined in claim 1, wherein the time schedule has at least one extended time interval to extend a promotion time or at least one shortened time interval to surprisingly shorten a promotion time.

11. A time-restricted product sale promotion method comprising the steps of:
providing a time-restricted degressive mechanism on a product sale promotion platform and providing a real-time price-reporting system to connect with the product sale promotion platform;
connecting a seller system to the product sale promotion platform to provide at least one sale product and promotion prices thereof, calculating and adjusting the promotion prices within a total restricted promotion time interval by the degressive mechanism to generate a series of optimum degressive sale prices of the sale product and a time schedule, and generating a real-time price reference from the real-time price-reporting system;
sending out the optimum degressive sale prices and the real-time price reference to a buyer system;
connecting the buyer system to the product sale promotion platform to send out a purchase order to the seller system via the product sale promotion platform according to the selected optimum degressive sale price with the time schedule;
comparing the purchase order with the corresponding optimum degressive sale price by a promotion management unit; and
displaying bargain data on the product sale promotion platform if the corresponding optimum degressive sale price and the purchase order are completely verified.

12. The time-restricted product sale promotion method as defined in claim 11, wherein the seller system connects with the product sale promotion platform to preset at least one time interval and total times of degressive promotion by the time-restricted degressive mechanism.

13. The time-restricted product sale promotion method as defined in claim 11, wherein the time-restricted degressive mechanism includes at least one correlation between degressive promotion prices and time.

14. The time-restricted product sale promotion method as defined in claim 11, wherein the optimum sale prices further combines with different extra bonuses or discount coupons.

15. The time-restricted product sale promotion method as defined in claim 11, wherein the sale product includes a combination of different promotion items which are provided to calculate a total of the promotion prices of the combination of the different promotion items.

16. The time-restricted product sale promotion method as defined in claim 11, wherein the promotion prices include an initial promotion price, a plurality of degressive promotion prices and a final promotion price.

17. The time-restricted product sale promotion method as defined in claim 11, wherein the real-time price-reporting system connects with at least one shopping website or shopping center to receive real-time prices of products therefrom.

18. The time-restricted product sale promotion method as defined in claim 11, wherein further comprising a differential price table between the real-time price reference and the optimum degressive sale prices generated from comparing the real-time price reference with the optimum degressive sale prices.

19. The time-restricted product sale promotion method as defined in claim 11, wherein the time schedule has degressive time intervals to compact a promotion time step by step.

20. The time-restricted product sale promotion method as defined in claim 11, wherein the time schedule has at least one extended time interval to extend a promotion time or at least one shortened time interval to surprisingly shorten a promotion time.
